(19) United States
(12) Patent Application Publication
(10) Pub. No.: US 2016/0149365 A1
(43) Pub. Date: May 26, 2016

(54) Light Bulb Socket Adapter

(71) Applicants: Jack Degginger, Joplin, MO (US); Jackie Degginger, Joplin, MO (US); Harold Degginger, Joplin, MO (US)

(72) Inventors: Jack Degginger, Joplin, MO (US); Jackie Degginger, Joplin, MO (US); Harold Degginger, Joplin, MO (US)

(21) Appl. No.: 14/712,515

(22) Filed: May 14, 2015

Related U.S. Application Data
(60) Provisional application No. 62/083,428, filed on Nov. 24, 2014.

(51) Int. Cl. H01R 33/22; H01R 33/94

(52) U.S. Cl. CPC H01R 33/22; H01R 33/94

(57) ABSTRACT

A light bulb socket adapter for allowing a light bulb with a small diameter base to be utilized in a conventional light fixture. The light bulb socket adapter includes a body with an open upper end having internal threading, wherein the upper end can receive a light bulb with a small diameter base. The interior of the open upper end includes an electrical contact plate adapted to contact the electrical foot contact of the light bulb inserted therein. The body includes a closed lower end with external threading that is adapted to engage a conventional light fixture. The lower end of the adapter includes an electrical foot contact that is electrically connected to the electrical contact plate of the interior of the open upper end of the light bulb socket adapter. In this way, electricity is provided through the light bulb socket adapter to the light bulb held therein.

### CROSS REFERENCE TO RELATED APPLICATION

This application claims the benefit of U.S. Provisional Application No. 62/083,428 filed on Nov. 24, 2014. The above identified patent application is herein incorporated by reference in its entirety to provide continuity of disclosure.

### BACKGROUND OF THE INVENTION

1. Field of the Invention

The present invention relates to light bulb socket adapters. More specifically, the present invention provides a light bulb socket adapter for use in allowing a light bulb with a small diameter base, such as a vintage or antique light bulb, to be utilized in a standard sized socket in conventional lighting devices. The light bulb socket adapter comprises a body having an open upper end adapted to receive a light bulb having a small diameter base and a closed lower end having external threading adapted to engage with the threaded interior of a standard light fixture socket.

Many light bulbs are not suitable for use with conventional lighting devices, such as table lamps, floor lamps, chandeliers, and other indoor/outdoor lighting fixtures. Such light bulbs may have a base that is too small to engage with the socket on the lighting fixtures. As a result, the user may be unable to use a light bulb that he or she has selected and must replace the light bulb with a light bulb of the appropriate size.

Vintage or antique light bulbs are commonly used to provide a unique and decorative lighting effect and to provide a soft glow that cannot be achieved by compact fluorescent bulbs. However, many vintage or antique light bulbs comprise a small diameter base that is not adapted to engage sockets of conventional light fixtures. As a result, the user may be unable to use the desired type of light bulb, or the user must replace the light fixture with another light fixture having a socket suitable to receive the light bulb. Replacing the entire light fixture can be expensive and inconvenient for the user. Thus, a device for allowing a light bulb with a small diameter base to be used with a conventional light fixture socket is desired.

Devices have been disclosed in the prior art that relate to light bulb socket adapters. These include devices that have been patented and published in patent application publications. Devices in the prior art such as U.S. Published Patent Application Number 2009/0253303, U.S. Patent Number 7,407,418, U.S. Pat. No. 5,989,070, and U.S. Pat. No. 3,452,215 provide adapters for allowing a light bulb socket to receive a different size or type of light bulb therein.

These prior art devices have several known drawbacks. The devices in the prior art fail to provide a light bulb socket adapter that allows a small diameter light bulb, such as vintage or antique light bulbs, to be used in the socket of a conventional light fixture, wherein the upper end is adapted to receive a small diameter light bulb therein and wherein the lower end can be engaged in the light fixture's socket. Further, such devices fail to provide a light bulb socket adapter having a key adapted to removably engage with slots on the light bulb socket adapter to facilitate removal of the socket adapter from the socket of a conventional light fixture.

In light of the devices disclosed in the prior art, it is submitted that the present invention substantially diverges in design elements from the prior art and consequently it is clear that there is a need in the art for an improvement to existing light bulb socket adapter devices. In this regard the instant invention substantially fulfills these needs.

### SUMMARY OF THE INVENTION

In view of the foregoing disadvantages inherent in the known types of light bulb socket adapters now present in the prior art, the present invention provides a new light bulb socket adapter wherein the same can be utilized for providing convenience for the user when utilizing a light bulb having a small diameter base with a conventional light fixture socket.

It is therefore an object of the present invention to provide a new and improved light bulb socket adapter device that has all of the advantages of the prior art and none of the disadvantages.

It is another object of the present invention to provide a light bulb socket adapter device having a body with an open upper end adapted to receive a light bulb therein and a lower end adapted to be inserted into a light fixture socket.

Another object of the present invention is to provide a light bulb socket adapter device having threading on the external surface of the lower end thereof for engaging with a light fixture socket.

Yet another object of the present invention is to provide a light bulb socket adapter device having slots thereon and having a key that can be engaged with the slots to facilitate removal of the light bulb socket adapter device.

Another object of the present invention is to provide a light bulb socket adapter device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the light bulb socket adapter of the present invention.

FIG. 2 shows a cross sectional view of the light bulb socket adapter as positioned to receive a light bulb and for insertion into a light fixture socket.

FIG. 3 shows a perspective views of the light bulb socket adapter and the key used to facilitate removal of the light bulb socket adapter from a socket.

### DETAILED DESCRIPTION OF THE INVENTION

Reference is made herein to the attached drawings. Like reference numerals are used throughout the drawings to depict like or similar elements of the light bulb socket adapter. For the purposes of presenting a brief and clear description of the present invention, the preferred embodiment will be discussed as used for allowing a light bulb with a small diameter base to be used with a conventional light fixture socket. The figures are intended for representative purposes only and should not be considered to be limiting in any respect.

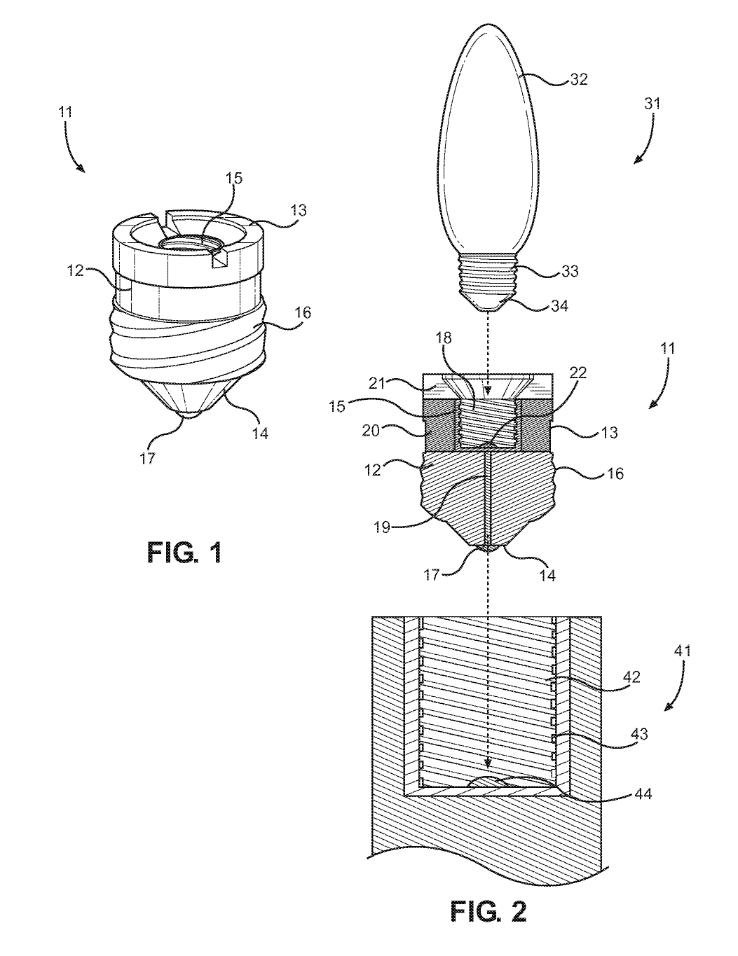

Referring now to FIG. 1, there is shown a perspective view of the light bulb socket adapter of the present invention. The light bulb socket adapter 11 comprises a body 12 having an upper end 13 having an opening providing access to an interior volume, and a closed lower end 14. The body 12 preferably comprises a circular cross section. The body 12 may include electrically insulating material such that electricity does not flow through the entirety of the body 12. The upper end 13 comprises internal threading 15 and the opening thereon is sized so as to receive a light bulb having a small diameter base.

The closed lower end 14 of the body 12 comprises external threading 16 adapted to engage with a socket of a conventional light fixture. In this way, the light bulb socket adapter 11 is adapted to be secured within a socket of a conventional light fixture in the same manner as a conventional light bulb. Once the light bulb socket adapter 11 is secured within the socket, the opening on the upper end 13 of the light bulb socket adapter 11 allows a user to secure a small diameter light bulb therein, so that the small diameter light bulb can be used in the conventional light fixture.

Referring now to FIG. 2, there is shown a cross sectional view of the light bulb socket adapter as positioned to receive a light bulb and for insertion into a light fixture socket. The upper end 13 of the body 12 of the light bulb socket adapter 11 comprises an interior volume 18 in which the base 33 of a light bulb 31 can be secured, wherein the bulb portion 32 of the light bulb 31 extends outward from the upper end 13 of the light bulb socket adapter 11. The base 33 of the light bulb is secured within the opening on the upper end 13 by engaging the internal threading 15 of the upper end 13 with the exterior threading 33 on the base of the light bulb 31. The base 33 of the light bulb 31 further includes an electrical foot contact 34 adapted to contact an electrical contact plate 22 on the interior volume 18 of the open upper end 13 of the light bulb socket adapter 11.

The lower end 14 of the body 12 of the light bulb socket adapter 11 comprises external threading 16 adapted to engage with the internal threading 43 of an electrical socket 41 of a light fixture. The electrical socket 41 comprises an interior volume 42 in which the lower end 14 of the body 12 of the light bulb socket adapter 11 can be positioned. The lower end 14 of the body 12 further includes an electrical foot contact 17 adapted to contact an electrical contact plate 44 within the socket 41 in order to form an electrical connection therewith. The electrical foot contact 17 on the lower end 14 of the body 12 is in electrical contact with the electrical contact plate 22 in the interior volume 18 of the upper end 13 of the light bulb socket adapter 11. The electrical foot contact 17 is connected to the electrical contact plate 22 via an electrically conducting wire 19.

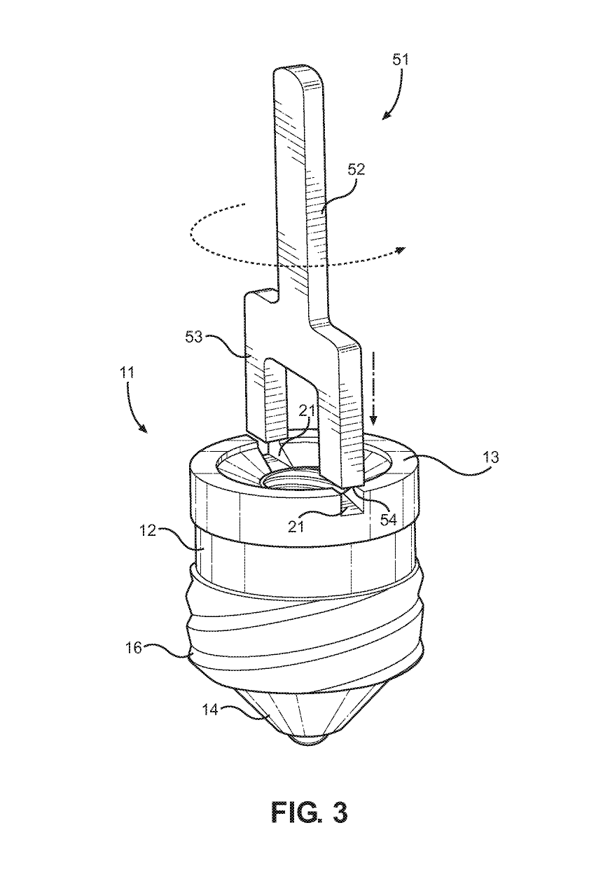

Referring now to FIG. 3, there is shown a perspective view of the light bulb socket adapter and of the key used to facilitate removal of the light bulb socket adapter from a socket. The body 12 of the light bulb socket adapter 11 further comprises a pair of slots 21 on opposing sides thereof adapted to engage with a key 51. The slots 21 are preferably located on the upper end 13 of the body 12 in an area above the external threading 16 such that the slots 21 are exposed when the light bulb socket adapter 11 is secured within a socket.

The key 51 is used to facilitate removal of the light bulb socket adapter 11 from a light bulb socket. When the light bulb socket adapter 11 is secured within a light bulb socket, only a small portion of the body 12 extends above the socket providing the user with little room to hold or grasp the light bulb socket adapter 11 in order to remove the same. Further, the light bulb socket adapter 11 may become hot during use from having electricity flow therethrough. Thus, the key 51 helps the user to more easily remove the light bulb socket adapter 11.

The key 51 comprises a handle 52 and a pair of arms 53, wherein the ends 54 of the arms 53 are adapted to engage with the slots 21 on the light bulb socket adapter 11. The ends 54 of the arms 53 can be removably positioned within the slots 21, and the user can hold the key 51 by the handle 52 and can twist the key in a circular, rotating motion about the socket so as to disengage the threading 16 on the body 12 from the internal threading of the socket in which the light bulb socket adapter 11 is secured.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A light bulb socket adapter, comprising:
a body comprising an upper end having an opening defining an interior volume, and a closed lower end;
wherein said opening has a smaller diameter than a diameter of said closed lower end of said body, and is adapted to receive a base of a light bulb having a small diameter base; and
wherein said closed lower end is adapted to be inserted into a socket of a light fixture.

2) The light bulb socket adapter of claim 1, wherein said upper end comprises a threaded interior so as to engage with a threaded exterior of said base of said light bulb.

3) The light bulb socket adapter of claim 1, wherein said closed lower end comprises exterior threading adapted to engage with internal threading of said socket of said light fixture.

4) The light bulb socket adapter of claim 1, wherein said interior volume of said upper end comprises an electrical contact plate adapted to contact said base of said light bulb.

5) The light bulb socket adapter of claim 4, wherein said closed lower end comprises an electrical foot contact for electrically connecting said body to said socket of said light fixture.

6) The light bulb socket adapter of claim 5, wherein an electrically conducting wire extends between said electrical contact plate of said upper end and said electrical foot contact of said closed lower end.

7) The light bulb socket adapter of claim 1, further comprising a pair of slots on said body adapted to engage with a key, wherein said key is adapted to allow a user to remove said body from said socket of said light fixture.

8) The light bulb socket adapter of claim 6, wherein said key comprises a handle and a pair of arms, wherein each of said pair of arms is adapted to be removably engaged with one of said pair of slots on said body.
